(19) United States
(12) Patent Application Publication
(10) Pub. No.: US 2026/0358467 A1
(43) Pub. Date: Nov. 12, 2026

(54) DUAL-POLARIZED MIMO RADAR

(71) Applicant: Robert Bosch Gmbh, Gerlingen (DE)

(72) Inventors: Paul W. Dent, Pittsboro, NC (US); Curtis Davis, St. Louis, MO (US); Murtaza Ali, Cedar Park, TX (US); Frederick Rush, Auburn, AL (US); Monier Maher, St. Louis, MO (US); Marius Goldenberg, Austin, TX (US)

(21) Appl. No.: 19/734,736

(22) Filed: Jul. 8, 2026

Related U.S. Application Data
(63) Continuation of application No. 17/582,672, filed on Jan. 24, 2022, now Pat. No. 12,681,135.
(60) Provisional application No. 63/141,020, filed on Jan. 25, 2021.

(51) Int. Cl. G01S 7/02; G01S 7/41; G01S 13/931

(52) U.S. Cl. CPC G01S 7/024; G01S 7/414; G01S 13/931; G01S 2013/93271; G01S 2013/93272

(57) ABSTRACT

A radar system with at least one transmitter and at least one receiver. The transmitter configured to transmit radio signals and the receiver configured to receive radio signals that include (i) first radio signals transmitted by the transmitter and reflected from objects in an environment, and (ii) other radio signals that include second radio signals transmitted by another radar system. The receiver is configured to increase a signal handling dynamic range. The increase in signal handling dynamic range is defined by the dynamic range necessary to avoid the receiver saturating at a first analog-to-digital (A-to-D) converter stage of the receiver before the received radio signal has reached a digital signal processing domain.

### CROSS REFERENCE TO RELATED APPLICATIONS

The present application claims priority to and is a continuation of U.S. patent application Ser. No. 17/582,672, filed Jan. 24, 2022, which claims the benefits of U.S. provisional application, Ser. No. 63/141,020, filed Jan. 25, 2021, which are hereby incorporated by reference herein in their entireties.

### FIELD OF THE INVENTION

The present invention is directed to radar systems, and more particularly to radar systems for vehicles and robotics.

### BACKGROUND OF THE INVENTION

The use of radar to determine range, velocity, and angle (elevation or azimuth) of objects in an environment is important in a number of applications including automotive radar and gesture detection. Radar systems typically transmit a radio frequency (RF) signal and listen for the reflection of the radio signal from objects in the environment. A radar system estimates the location of objects, also called targets, in the environment by correlating delayed versions of the received radio signal with the transmitted radio signal. A radar system can also estimate the velocity of the target by Doppler processing. A radar system with multiple transmitters and multiple receivers can also determine the angular position of a target. Depending on antenna scanning and/or the number of antenna/receiver channels and their geometry, different angles (e.g., azimuth or elevation) can be determined.

A radar system consists of transmitters and receivers. The transmitters generate a baseband signal which is upconverted to a radio frequency (RF) signal that propagates according to an antenna pattern. The transmitted signal is reflected off of object or targets in the environment. The received signal at each receiver is the totality of the reflected signal from all targets in the environment. The receiver down converts the received signal to baseband and compares the baseband received signal to the baseband signal at one or more transmitters. This is used to determine the range, velocity, and angle of targets in the environment.

### SUMMARY OF THE INVENTION

Embodiments of the present invention provide for a radar system that provides for greater immunity to interference from other radar systems, particularly from chirp radars. Exemplary embodiments also provide “good citizen” measures that help to reduce interference that might be caused to other radar systems. An exemplary radar system will include dual polarization receive channels in the expectation that interference will be a different polarization than the desired radio signals transmitted by own transmitters and reflected from targets in the environment. The radar system provides improved signal handling dynamic range to avoid receive channels saturating at the A-to-D converter stage before the radio signal has reached the digital signal processing domain.

In an aspect of the present invention, a radar system includes a transmit pipeline that includes a plurality of transmitters. The radar system also includes a receive pipeline that includes a plurality of receivers. The transmitters are configured to transmit radio signals. The receivers are configured to receive radio signals that include the transmitted radio signals transmitted by the transmitters and reflected from objects in the environment. The receive pipeline is configured to provide interference immunity from interfering radio signals transmitted by other radar systems.

In an aspect of the present invention, the interfering radar systems may be chirp radars.

In another aspect of the present invention, the transmit pipeline and/or the receive pipeline is configured to avoid transmitting radio signals that interfere with the other radar systems.

In a further aspect of the present invention, the receive pipeline comprises exemplary dual polarization receive channels. The interfering radio signals are a different polarization than the radio signals transmitted by the transmitters and reflected from targets in the environment.

In yet another aspect of the present invention, the receive pipeline is configured to provide improved signal handling dynamic range to avoid receive channels saturating at the A-to-D converter stage before the radio signal has reached the digital signal processing domain.

These and other objects, advantages, purposes and features of the present invention will become apparent upon review of the following specification in conjunction with the drawings.

### BRIEF DESCRIPTION OF THE DRAWINGS

FIG. 1 is a plan view of an automobile equipped with a radar system in accordance with the present invention;

FIG. 2A and FIG. 2B are block diagrams of radar systems in accordance with the present invention;

FIG. 3 is a block diagram illustrating a radar with a plurality of receivers and a plurality of transmitters (MIMO radar) in accordance with the present invention;

FIG. 4 is a block diagram of an exemplary dual-polarized MIMO radar system with dual polarization receive channels in accordance with the present invention; and

FIG. 5 is a plan view of an exemplary arrangement of ball-bonds in accordance with the present invention.

### DESCRIPTION OF THE PREFERRED EMBODIMENTS

Referring to the drawings and the illustrative embodiments depicted therein, wherein numbered elements in the following written description correspond to like-numbered elements in the figures, a radar system provides for greater immunity to interference from other radar systems, particularly chirp radars. The exemplary radar system also provides “good citizen” measures that help to reduce interference that might be caused to other radar systems. The radar system will include exemplary dual polarization receive channels in the expectation that interference will be a different polarization than the desired radio signals transmitted by own transmitters and reflected from targets in the environment. The radar system also provides improved signal handling dynamic range to avoid receive channels saturating at the A-to-D converter stage before the radio signal has reached the digital signal processing domain.

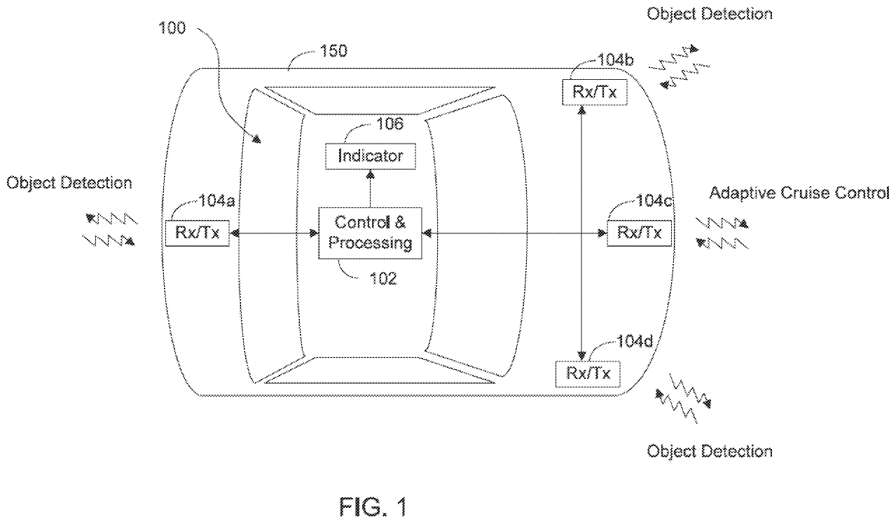

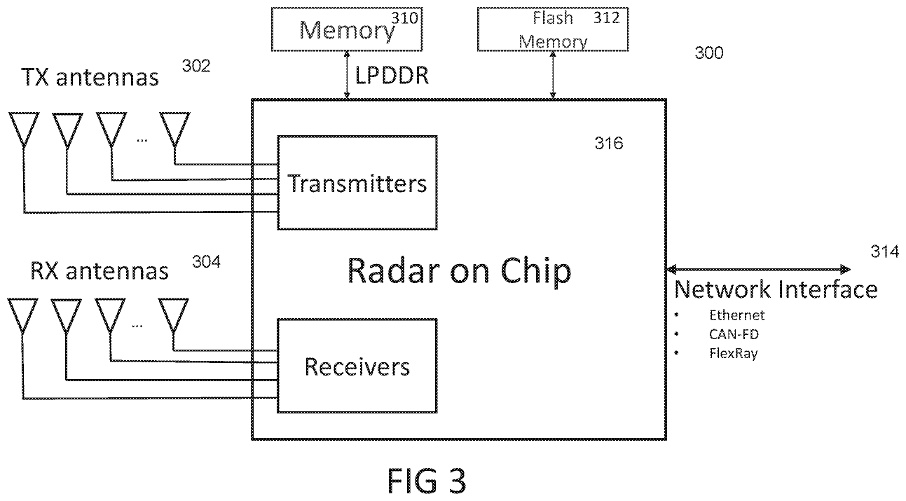

FIG. 1 illustrates an exemplary radar system 100 configured for use in a vehicle 150. In an aspect of the present invention, a vehicle 150 may be an automobile, truck, or bus, etc. The radar system 100 may utilize multiple radar systems (e.g., 104a-104d) embedded in the vehicle 150 (see FIG. 1). Each of these radar systems may employ multiple transmitters, receivers, and antennas (see FIG. 3). These signals are reflected from objects (also known as targets) in the environment and received by one or more receivers of the radar system. A transmitter-receiver pair is called a virtual radar (or sometimes a virtual receiver). As illustrated in FIG. 1, the radar system 100 may comprise one or more transmitters and one or more receivers (104a-104d) for a plurality of virtual radars. Other configurations are also possible. FIG. 1 illustrates the receivers/transmitters 104a-104d placed to acquire and provide data for object detection and adaptive cruise control. As illustrated in FIG. 1, a controller 102 receives and then analyzes position information received from the receivers 104a-104d and forwards processed information (e.g., position information) to, for example, an indicator 106 or other similar devices, as well as to other automotive systems. The radar system 100 (providing such object detection and adaptive cruise control or the like) may be part of an Advanced Driver Assistance System (ADAS) for the automobile 150.

An exemplary radar system operates by transmitting one or more signals from one or more transmitters and then listening for reflections of those signals from objects in the environment by one or more receivers. By comparing the transmitted signals and the received signals, estimates of the range, velocity, and angle (azimuth and/or elevation) of the objects can be estimated.

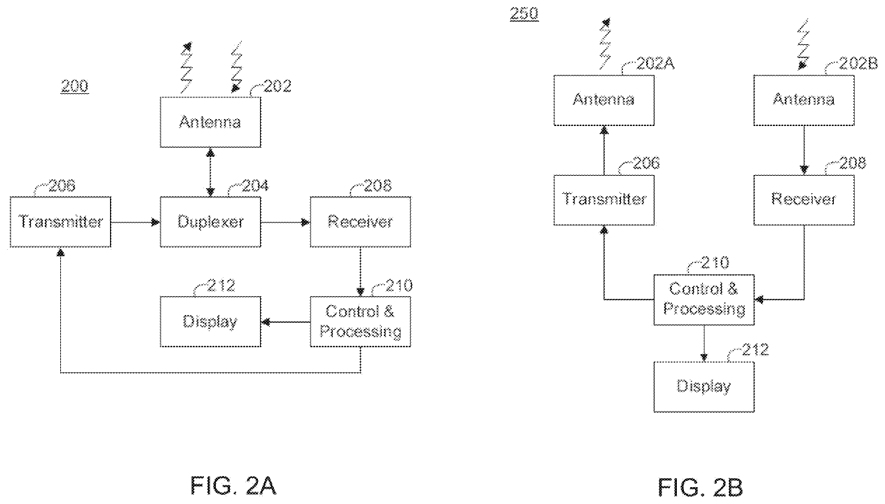

There are several ways to implement a radar system. One way, illustrated in FIG. 2A, uses a single antenna 202 for transmitting and receiving. The antenna 202 is connected to a duplexer 204 that routes the appropriate signal from the antenna 202 to a receiver 208 or routes the signal from a transmitter 206 to the antenna 202. A control processor 210 controls the operation of the transmitter 206 and the receiver 208 and estimates the range and velocity of objects in the environment. A second way to implement a radar system is shown in FIG. 2B. In this system, there are separate antennas for transmitting (202A) and receiving (202B). A control processor 210 performs the same basic functions as in FIG. 2A. In each case, there may be a display 212 to visualize the location of objects in the environment.

A radar system with multiple antennas, multiple transmitters, and multiple receivers is shown in FIG. 3. Using multiple antennas 302, 304 allows an exemplary radar system 300 to determine the angle (azimuth or elevation or both) of targets in the environment. Depending on the geometry of the antenna system, different angles (e.g., azimuth or elevation) can be determined.

The radar system 300 may be connected to a network via an Ethernet connection or other types of network connections 314, such as, for example, CAN-FD and FlexRay. The radar system 300 may also have memory (310, 312) to store software used for processing the signals in order to determine range, velocity, and location of objects. Memory 310, 312 may also be used to store information about targets in the environment. There may also be processing capability contained in the ASIC 208 apart from the transmitters 203 and receivers 204.

The description herein includes an exemplary radar system in which there are N_{T} transmitters and N_{R} receivers for N_{T}×N_{R} virtual radars, one for each transmitter-receiver pair. For example, a radar system with eight transmitters and eight receivers will have 64 pairs or 64 virtual radars (with 64 virtual receivers). When three transmitters (Tx1, Tx2, Tx3) generate signals that are being received by three receivers (Rx1, Rx2, Rx3), each of the receivers is receiving the transmission from each of the transmitters reflected by objects in the environment. Each receiver can attempt to determine the range and Doppler of objects by correlating with delayed replicas of the signal from each of the transmitters. The physical receivers may then be “divided” into three separate virtual receivers, each virtual receiver correlating with delay replicas of one of the transmitted signals.

There are several different types of signals that transmitters in radar systems employ. A radar system may transmit a pulsed signal or a continuous signal. In a pulsed radar system, the signal is transmitted for a short time and then no signal is transmitted. This is repeated over and over. When the signal is not being transmitted, the receiver listens for echoes or reflections from objects in the environment. Often a single antenna is used for both the transmitter and receiver and the radar transmits on the antenna and then listens to the received signal on the same antenna. This process is then repeated. In a continuous wave radar system, the signal is continuously transmitted. There may be an antenna for transmitting and a separate antenna for receiving.

Another classification of radar systems is in the modulation of the signal being transmitted. A first type of continuous wave radar signal is known as a frequency modulated continuous wave (FMCW) radar signal. In an FMCW radar system, the transmitted signal is a continuous sinusoidal signal with a varying frequency. By measuring a time difference between when a certain frequency was transmitted and when the received signal contained that frequency, the range to an object can be determined. By measuring several different time differences between a transmitted signal and a received signal, velocity information can be obtained.

A second type of continuous wave signal used in radar systems is known as a phase modulated continuous wave (PMCW) radar signal. In a PMCW radar system, the transmitted signal from a single transmitter is a continuous sinusoidal signal in which the phase of the sinusoidal signal varies. Typically, the phase during a given time-period (called a chip period or chip duration) is one of a finite number of possible phases. A spreading code consisting of a sequence of chips, (e.g., +1, +1, −1, +1, −1 . . . ) is mapped (e.g., +1→0 radians, −1→π radians, where +1 corresponds to a phase of 0 radians and −1 corresponds to a phase of π radians) into a sequence of phases (e.g., 0, 0, π, 0, π . . . ) that is used to modulate a carrier signal to generate the radio frequency (RF) signal. The spreading code could be a periodic sequence or could be a pseudo-random sequence with a very large period, so it appears to be a nearly random sequence. The spreading code could be a binary code (e.g., +1 or −1). The resulting signal has a bandwidth that is proportional to the rate at which the phases change, called the chip rate R_{c}, which is the inverse of the chip duration T_{c}=1/R_{c}. By comparing the return signal to the transmitted signal, the receiver can determine the range and the velocity of reflected objects.

In some radar systems, the signal (e.g., a PMCW signal) is transmitted over a short time-period (e.g., 1 microsecond) and then turned off for a similar time-period. The receiver is only turned on during the time-period where the transmitter is turned off. In this approach, reflections of the transmitted signal from very close targets will not be completely available because the receiver is not active during a large fraction of the time when the reflected signals are being received. This is called pulse mode.

The radar sensing system of the present invention may utilize aspects of the radar systems described in U.S. Pat. Nos. 10,261,179; 9,971,020; 9,954,955; 9,945,935; 9,869,762; 9,846,228; 9,806,914; 9,791,564; 9,791,551; 9,772,397; 9,753,121; 9,599,702; 9,575,160, and/or 9,689,967, and/or U.S. Publication Nos. 2018/0231656, 2018/0231652, 2018/0231636, and 2017/0309997, and/or U.S. provisional applications, Ser. No. 62/486,732, filed Apr. 18, 2017, Ser. No. 62/528,789, filed Jul. 5, 2017, Ser. No. 62/573,880, filed Oct. 18, 2017, Ser. No. 62/598,563, filed Dec. 14, 2017, Ser. No. 62/623,092, filed Jan. 29, 2018, and/or Ser. No. 62/659,204, filed Apr. 18, 2018, which are all hereby incorporated by reference herein in their entireties.

Digital frequency modulated continuous wave (FMCW) and phase modulated continuous wave (PMCW) are techniques in which a carrier signal is frequency or phase modulated, respectively, with digital codes using, for example, GMSK (Gaussian minimum shift keying). Digital FMCW radar lends itself to be constructed in a MIMO variant in which multiple transmitters transmitting multiple codes are received by multiple receivers that decode all codes. The advantage of the MIMO digital FMCW radar is that the angular resolution is that of a virtual antenna array having an equivalent number of elements equal to the product of the number of transmitters and the number of receivers. Digital FMCW MIMO radar techniques are described in U.S. Pat. Nos. 9,989,627; 9,945,935; 9,846,228; and 9,791,551, which are all hereby incorporated by reference herein in their entireties.

### Dual-Polarized Multiple-Input, Multiple-Output (Mimo) Radar

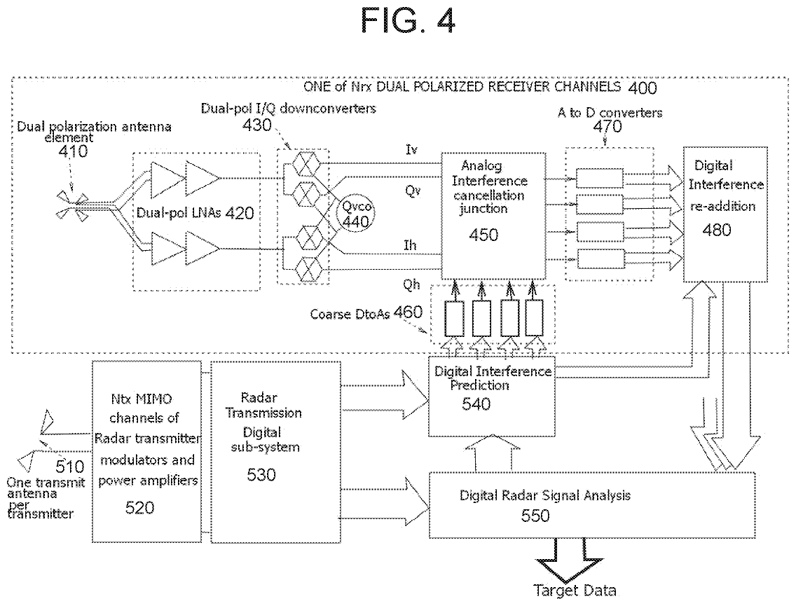

FIG. 4 is a block diagram of an exemplary radar system that provides for greater immunity to interference from other radar systems, particularly chirp radars. The exemplary radar system comprises a plurality of transmission channels 520 coupled to associated antennas 510. A digital sub-system 530 receives the radar transmission, which is delivered to a digital interference prediction step 540 and a digital radar signal analysis domain 550. Dual-polarization low noise amplifiers (LNAs) 200 of an exemplary dual polarized receiver channel 400 receive respective horizontal and vertical polarization radio signals from associated dual polarization antenna elements 410. The vertical and horizontally polarized radio signals are downconverted into respective vertical I, Q and horizontal I, Q signals by dual-polarization I/Q downconverters 430 and a quad VCO 440, and input to an analog interference cancellation junction 450. The exemplary radar system also provides “good citizen” measures that help to reduce interference (from the radar system) that might be caused to other radar systems. The radar system will include exemplary dual polarization receive channels 400 in the expectation that interference will be a different polarization than the desired radio signals transmitted by own transmitters and reflected from targets in the environment. The radar system also provides an improved signal handling dynamic range to avoid the receive channels saturating at the A-to-D converter stage 470 before the radio signal has reached the digital signal processing domain 480, 550.

The exemplary radar system of FIG. 4 improves the dynamic range up to and including the analog-to-digital (A-to-D) converters 470 by using the results of digital radar signal analysis to date from the digital signal processing domain 550 in a digital signal prediction step 540 to construct a digital prediction of the receiver channel signals to be received at a future time (e.g., 1μs into the future). The dynamic range may also be improved by digital-to-analog (D-to-A) converting the digital predictions into the analog domain using, for example, coarse digital-to-analog converters 460 and to then subtract the analog interference prediction signals from the corresponding receive channel signals in a summing or subtracting junction (e.g., the analog interference cancellation junction 450), such that the residual signals presented to the A-to-D converters 470 are of a reduced amplitude but still filling the dynamic range of the A-to-D converters 470. Thus, the total dynamic range for signal handling is equal to the dynamic range of the A-to-D converters 470 enhanced by the amount by which interference subtraction lowered the residuals. One way to think of it is that the coarse D-to-A converters 460 might slice off the top 4 bits of signal dynamic range leaving the bottom 6 bits only to be converted by A-to-D converters 470, and thereby achieving the equivalent of a 10-bit conversion.

To achieve the accuracy of, for example, a 10-bit conversion, the amount of interference subtracted in the analog domain has to be added back in the digital interference re-addition module 480 with high accuracy. The method envisaged to do this is that each level (perhaps 16 to 64 levels) of each of the coarse D-to-A converters 460 will have an auto-learned digital word to describe it, which will be adaptively learned to a high accuracy so that when that level is subtracted in the analog domain (in the analog interference cancellation junction module 450), an accurate digital value will be added back in the digital interference re-addition module 480.

It is assumed that, after the A-to-D converters 470 of limited word length, the digital signal processing thereafter (e.g., via the digital radar signal analysis module 550 and/or subsequent data processors) can have whatever word length is needed to avoid digital saturation.

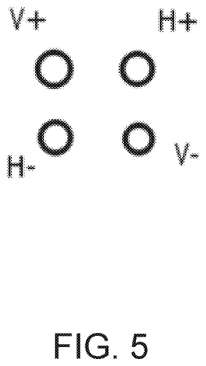

The analog interference subtraction (via the analog interference cancellation junction module 450) should occur as early as possible in the analog path. In one exemplary embodiment, the analog interference subtraction is performed after downconversion to the (I, Q) baseband (which was performed via the dual-polarization downconverters 430 and the quad VCO 440). It is seen that the subtraction is often complex and power consuming to convert the predictions to 80 GHz for subtraction in the RF domain; and moreover, causes significant noise factor degradation. To do that, measures must be taken to avoid local transmit-receive spillover, such as separating transmit and receive chips, separation between transmit and receive antennas arrays, and use of a balanced RF I/O. For dual-polarization receivers (e.g., containing dual polarized receiver channels 400), the balanced dual-polarization antenna (V, H) connection to the dual polarization antenna element 410 can comprise four ball-bonds in a square as shown in FIG. 5.

When arranged in the above way, the signals are nominally spatially orthogonal and any residual coupling between them can hardly be important given that the dual-polarization antenna is also crossed-dipoles for example.

With the availability of the dual-polarization signals from Nrx receivers and both polarizations, the digital radar signal analysis 550 can comprise, as previously seen, of an FFT-based scheme for pulse-by-pulse correlation of the received signal in each channel with the known transmitter codes. If this is done, note that transmitting with a GMSK. UMSK modulation using the GSM 90-degree per bit pre-rotation coding reduces the correlation to correlating a complex received signal with a real template, rather than a full complex* complex correlation. There might however be even faster and less power consuming correlation methods that need no multiplies, which can be when the same received signal is to be correlated with many binary codes (many shifts of many different codes is a large number of binary correlations). These are based on the fact that the number of possible bit patterns of finite length, such as 8, is 256 times however many codes are used to correlate with, and since the same 256-bit patterns will reoccur many times in many codes, 8 signal samples need be combined only once in all 256 ways, and by doing it in Gray code order, only one new addition is required for each combination. (The latter alone is an 8:1 speed up).

There is an advantage in the per-pulse FFT correlation method. When the signal is temporarily available in the frequency domain, narrow-band interference stands out and can be clipped, nulled or otherwise mitigated.

An advance on interference nulling in the spectral domain only is to perform a rough beamforming over all antenna channels for each FFT component. A rough beamforming over, for example, 16 receive channels can be a 16-point FFT. Whatever is used, it should be an easily invertible, information lossless transform, but not necessarily an orthogonal transform like the FFT.

The combination of a 256-pt FFT for correlation with a 16-pt FFT over corresponding spectral components of the 256-pt FFT is in fact a 256×16 2-D FFT, which is a 2,048-pt Walsh-Fourier transform. The difference between a 2,048-pt Fourier transform and a Walsh-Fourier transform is that the former has twiddles at each stage while the latter omits twiddles between certain stages corresponding to the “Walsh” part. So, there are no twiddles between the 256-pt correlation FFT and the 16-pt beamforming FFT.

After a rough beamforming of each FFT component, the signal is in the 3D domain of spectrum and space. Nulling out large components at particular frequencies and in particular spatial directions removes less of the wanted signal energy. Moreover, the directions from which other-radar interference is received are likely to be long-term stable. Therefore, the directions in which to null-out spectral components of the interference can be determined over many pulses or even scans and do not change even if the interference spectrum changes.

Polarization can be added as yet another dimension in which to segregate interference. Since the polarization of other radar interference is also likely to be long-term stable, it can be determined solidly and then the following algorithm can be used to annul it to great advantage even though the polarization domain has only two points.

For example, for each spatio-spectral component to be cleaned up, the equation αV+βH is formed, where V and H are the horizontal and vertical components (or other cross-polarized components such as +/−45). The resulting polarization, which is determined by the ratio of α to β, is orthogonal to the interferer's polarization. However, but the scaling of α and β is chosen to leave the signal component unattenuated. Unattenuated within reason—if the polarizations of the signal and interferer were close, α and β would become large, magnifying noise. Thus, in at least that case, there is a compromise between noise magnification and signal loss that is known from many other similar problems.

So, using all 3 domains (i.e., spectral, spatial and polarization), substantial reduction of interference from other radars can already be obtained at the per-pulse stage. It is possible that only a single polarization, the above weighted combination of V and H, need be passed on to be accumulated over all pulses.

Inverting the rough beamforming needs to be done only once on the accumulated array just before the correlation IFFTs are performed.

The additional complexity introduced for spatio-spectral-polarization interference nulling is a doubling of the number of correlation FFTs to be performed, as there is one for each polarization. This is needed on the assumption that different interferers in different parts of the spectrum (or lying in different directions) might have different polarizations. Thus, even though their polarizations may be known in advance, if they are not the same, a polarization combination cannot be performed ahead of the FFT and rough beamforming FFT. Instead, the interferences need to be separated by spectrum and direction in order to apply a polarization nulling adapted to each one.

In addition, the exemplary embodiment illustrated in FIG. 4 includes the rough beamforming FFTs. This includes 256, 16-point beamforming FFTs after sixteen 16×16 point correlation FFTs (assuming 16 receivers, one FFT per RX (and per TX)). This is less than a 50% increase in processing, as the FFT has twiddles between its two stages of 16 pt FFTs, while no twiddles are needed between the FFTs and the beamforming.

Thus, the exemplary embodiments discussed herein include an exemplary radar system that provides for greater immunity to interference from other radar systems, particularly from chirp radars. The exemplary radar system also provides “good citizen” measures that help to reduce interference (by the radar system) that might be caused to other radar systems. The radar system includes exemplary dual polarization receive channels in the expectation that interference will be a different polarization than the desired radio signals transmitted by own transmitters and reflected from targets in the environment. The radar system also provides an improved signal handling dynamic range to avoid receive channels saturating at the A-to-D converter stage before the radio signal has reached the digital signal processing domain.

Changes and modifications in the specifically described embodiments can be carried out without departing from the principles of the present invention, which is intended to be limited only by the scope of the appended claims, as interpreted according to the principles of patent law including the doctrine of equivalents.

1. A radar system comprising:
a transmitter configured to transmit radio signals; and
a receiver comprising a receive channel configured to receive radio signals that include (i) first radio signals transmitted by the transmitter and reflected from objects in an environment, and (ii) other radio signals that include second radio signals transmitted by another radar system;
wherein the receiver is configured to increase a signal handling dynamic range, wherein the increase in signal handling dynamic range is defined by the dynamic range necessary to avoid the receiver saturating at a first analog-to-digital (A-to-D) converter stage of the receiver before the received radio signal has reached a digital signal processing domain.

2. The radar system of claim 1 further comprising:
a signal analysis module configured to predict anticipated receive channel signals to be received based upon previously received radio signals;
a course digital-to-analog (D-to-A) converter configured to D-to-A convert the predicted receive channel signals into analog predicted signals; and
a summing junction configured to subtract the analog predicted signals from the received radio signals to produce residual signals, wherein the residual signals presented to the first A-to-D converter stage are of a reduced amplitude but still filling the dynamic range of the first A-to-D converter stage.

3. The radar system of claim 2 further comprising a re-addition module configured add a digital value to digital outputs of the first A-to-D converter stage, wherein the digital value is defined by the analog predicted signals which were subtracted by the summing junction.

4. The radar system of claim 2, wherein the summing junction is configured to receive downconverted radio signals, wherein the downconverted radio signals are downconverted to the (I, Q) baseband.

5. The radar system of claim 2, wherein the predicted receive channel signals are defined at least in part by the previously received radio signals.

6. The radar system of claim 2, wherein the signal analysis module is configured to perform correlation transforms comprising a fast Fourier transform combined with a Walsh-Fourier transform on the received radio signals to predict the anticipated receive channel radio signals to be received.

7. The radar system of claim 1, wherein the first radio signals have a first polarity, and wherein the second radio signals have a second polarity that is different from the first polarity.

8. The radar system of claim 7, wherein the receive channel is a dual polarization receive channel configured to process the first radio signals separately from the second radio signals, and wherein the receiver is configured to perform correlation transforms and beamforming transforms for each polarization.

9. The radar system of claim 1, wherein the another radar system is a chirp radar system, and wherein the second radio signals are unknown to the receiver.

10. The radar system of claim 1, wherein at least one of the transmitter and receiver is configured to avoid transmitting radio signals that interfere with the another radar system.

11. A radar system comprising:
a plurality of transmitters each configured to transmit radio signals; and
a plurality of receivers each comprising a respective receive channel configured to receive radio signals that include (i) first radio signals transmitted by the transmitters and reflected from objects in an environment, and (ii) other radio signals that include second radio signals transmitted by another radar system;
wherein a first receiver of the plurality of receivers is configured to increase a signal handling dynamic range, wherein the increase in signal handling dynamic range is defined by the dynamic range necessary to avoid the first receiver saturating at a first analog-to-digital (A-to-D) converter stage of the first receiver before the received radio signal has reached a digital signal processing domain.

12. The radar system of claim 11 further comprising:
a signal analysis module configured to predict anticipated receive channel signals to be received based upon previously received radio signals;
a course digital-to-analog (D-to-A) converter configured to D-to-A convert the predicted receive channel signals into analog predicted signals; and
a summing junction configured to subtract the analog predicted signals from the received radio signals to produce residual signals, wherein the residual signals presented to the first A-to-D converter stage of the first receiver are of a reduced amplitude but still filling the dynamic range of the first A-to-D converter stage.

13. The radar system of claim 12 further comprising a re-addition module configured add a digital value to digital outputs of the first A-to-D converter stage of the first receiver, wherein the digital value is defined by the analog predicted signals which were subtracted by the summing junction.

14. The radar system of claim 12, wherein the summing junction is configured to receive downconverted radio signals, wherein the downconverted radio signals are downconverted to the (I, Q) baseband.

15. The radar system of claim 12, wherein the predicted receive channel signals are defined at least in part by the previously received radio signals.

16. The radar system of claim 12, wherein the signal analysis module is configured to perform correlation transforms comprising a fast Fourier transform combined with a Walsh-Fourier transform on the received radio signals to predict the anticipated receive channel radio signals to be received.

17. The radar system of claim 11, wherein the first radio signals have a first polarity, and wherein the second radio signals have a second polarity that is different from the first polarity.

18. The radar system of claim 17, wherein the receive channel of the first receiver is a dual polarization receive channel configured to process the first radio signals separately from the second radio signals, and wherein the first receiver is configured to perform correlation transforms and beamforming transforms for each polarization.

19. The radar system of claim 11, wherein the another radar system is a chirp radar system, and wherein the second radio signals are unknown to the first receiver.

20. The radar system of claim 11, wherein at least one of the transmitters and receivers is configured to avoid transmitting radio signals that interfere with the another radar system.
